(19) United States
(12) Patent Application Publication
(10) Pub. No.: US 2020/0033748 A1
(43) Pub. Date: Jan. 30, 2020

(54) INFORMATION PROCESSING APPARATUS AND IMAGE FORMING APPARATUS

(71) Applicant: CANON KABUSHIKI KAISHA, Tokyo (JP)

(72) Inventor: Takayuki Miyamoto, Abiko-shi (JP)

(21) Appl. No.: 16/514,804

(22) Filed: Jul. 17, 2019

(30) Foreign Application Priority Data
Jul. 30, 2018 (JP) 2018-142459

(51) Int. Cl. G03G 15/043

(52) U.S. Cl. CPC G03G 15/043

(57) ABSTRACT

An information processing apparatus is connected to an image forming apparatus including an image forming unit. The image forming unit includes a first receiver, a light source, a photosensitive member, a rotational polygon mirror, a light receiving unit, an identifier for identifying a reflection face, a first outputting unit for outputting a first signal, and a generator for generating a second signal. The information processing apparatus includes a second receiver, a measurement unit for measuring a length of a period when the second signal is at the first level, a determiner for determining a reflection face, a memory for storing a plurality of pieces of correction data, a corrector for correcting the image data based on the correction data and information indicating a reflection face, and a second outputting unit for starting outputting the image data corrected by the corrector to the image forming unit.

### BACKGROUND OF THE INVENTION

### Field of the Invention

The aspect of the embodiments relates to an information processing apparatus which corrects image data and transmits the image data to an image forming apparatus, and the image forming apparatus to which the information processing apparatus is connected.

### Description of the Related Art

Conventionally, there has been known an electrophotographic image forming apparatus using a laser device, which forms a latent image on an outer circumferential surface of a photosensitive drum by scanning the outer circumferential surface of the photosensitive drum with laser light deflected by a rotating polygon mirror.

The each face of the polygon mirror for deflecting laser light has a different shape. If each of the faces have a different shape, a latent image formed on the outer circumferential surface of the photosensitive drum with laser light deflected on the respective faces will be distorted.

Therefore, United States Patent Application Publication No. 2013/0141510 discusses a configuration in which a face of a polygon mirror for deflecting laser light is identified by an image controller through face identification based on time intervals of adjacent pulses of a main scanning synchronization signal input thereto. Specifically, the image controller measures time intervals of adjacent pulses and executes processing for identifying the face corresponding to each of the pulses based on the measurement result. The image controller executes correction corresponding to each of the faces (e.g., correction of a writing-start position of an image) on the image data. Image formation is executed based on the corrected image data. In addition, the face identification is executed before an image of one page is formed.

Japanese Patent Application Laid-Open No. 2000-313140 discusses a configuration in which an engine controller and a video controller transmit and receive data via a signal line. Further, Japanese Patent Application Laid-Open No. 2000-313140 further discusses a configuration in which a timing for starting image formation is determined by using a signal line for transmitting a main scanning synchronization signal to the video controller from the engine controller. Specifically, output of the main scanning synchronization signal is stopped when image formation for one face (one page) of the recording medium is ended. Then, image formation is executed on a photosensitive drum at a timing that output of the main scanning synchronization signal is restarted. In other words, a timing for starting image formation is determined based on a timing that the output of the main scanning synchronization signal is restarted.

In a case where the face identification is executed based on time intervals of adjacent pulses of the input main scanning synchronization signal as described in United States Patent Application Publication No. 2013/0141510, it is necessary to provide time for measuring the time intervals of the adjacent pulses and time for executing processing for identifying the faces corresponding to the respective pulses based on the measurement result.

Further, in a configuration described in Japanese Patent Application Laid-Open No. 2000-313140 in which a timing for starting image formation is determined by only the main scanning synchronization signal, every time image formation for one face of the recording medium is ended, there is a period in which the main scanning synchronization signal is not input to the image controller. Accordingly, when image formation for one face of the recording medium is completed, the image controller cannot figure out the face of the polygon mirror on which laser light is deflected. Therefore, in a case where the configuration described in United States Patent Application Publication No. 2013/0141510 is applied to the configuration described in Japanese Patent Application Laid-Open No. 2000-313140, the image controller has to measure the time intervals of the adjacent pulses and execute the processing for identifying the faces corresponding to the respective pulses based on the measurement result every time input of the main scanning synchronization signal to the image controller is restarted. In other words, every time image formation for one face of the recording medium is executed, the image controller has to measure the time intervals of the adjacent pulses and execute the processing for identifying the faces corresponding to respective pulses based on the measurement result. As a result, productivity of the image forming apparatus decreases. Therefore, there is a demand for a configuration for suppressing the decrease of productivity in image formation of one face of the recording medium while suppressing increase in cost.

### SUMMARY OF THE INVENTION

Aspects of the embodiments are directed to a configuration for preventing the decrease of productivity in image formation of one face of the recording medium while suppressing increase in cost.

According to an aspect of the embodiments, an information processing apparatus connected to an image forming apparatus including an image forming unit, the image forming unit includes a first receptor configured to receive image data, a light source configured to output light based on the image data received by the first receptor, a photosensitive body, a rotational polygon mirror having a plurality of reflection faces, configured to be rotated to scan the photosensitive body by deflecting the light output from the light source by using the plurality of reflection faces, a light receiving unit configured to receive the light deflected by the rotational polygon mirror, an identifier configured to identify a reflection face to be used for scanning the photosensitive body from among the plurality of reflection faces based on a light receiving result of the light receiving unit, a first outputting unit configured to output a first signal for determining a timing of starting the scanning of the photosensitive body with the light, and a generator configured to generate a second signal having a signal at a first level and a signal at a second level, wherein, in a period until the first signal is output from the first outputting unit after the identifier has completed identification of the reflection face, the generator generates the second signal based on the information about the reflection face identified by the identifier such that a first length as a length of a period of the first level corresponding to the identified reflection face from among the plurality of reflection faces is different from a second length as a length of a period of the first level corresponding to reflection faces other than the identified reflection face, and wherein, when the first signal is output from the first outputting unit, the generator generates the second signal such that a third length as a length of a period of the first level corresponding to a first reflection face from among the plurality of reflection faces is different from a fourth length as a length of a period of the first level corresponding to a second reflection face which is different from the first reflection face from among the plurality of reflection faces, and the information processing apparatus includes a second receptor configured to receive the second signal, a measurement unit configured to measure a length of a period when the second signal received by the second receptor is at the first level, a determiner configured to determine a reflection face to be used for scanning the photosensitive body based on a length of the period measured by the measurement unit and on a change of the second signal from the second level to the first level, a memory configured to store a plurality of pieces of correction data respectively corresponding to the plurality of reflection faces, a corrector configured to correct the image data corresponding to the reflection face based on the correction data stored in the memory and on information indicating the reflection face determined by the determiner, and a second outputting unit configured to start outputting the image data corrected by the corrector to the image forming unit based on a length of the period measured by the measurement unit after the determiner determines the reflection face.

Further features of the disclosure will become apparent from the following description of exemplary embodiments with reference to the attached drawings.

### BRIEF DESCRIPTION OF THE DRAWINGS

FIG. 1 is a cross-sectional diagram illustrating an image forming apparatus according to a first exemplary embodiment.

FIG. 2 is a diagram illustrating an example of image data read by a reader.

FIG. 3 is a block diagram illustrating a configuration of a laser scanner unit according to the first exemplary embodiment.

FIGS. 4A and 4B are diagrams illustrating examples of a relationship between a beam-detect (BD) signal generated by scanning a light receiving element of a BD sensor 1004 with laser light and a face (face number) on which the laser light is deflected.

FIG. 5 is a time chart illustrating a relationship between various signals and the number of counts M1 according to the first exemplary embodiment.

FIG. 6 is a flowchart illustrating control processing executed by an engine control unit according to the first exemplary embodiment.

FIG. 7 is a block diagram illustrating an example of a configuration of an image processing unit.

FIG. 8 is a flowchart illustrating control processing executed by an image control unit.

### DESCRIPTION OF THE EMBODIMENTS

Hereinafter, an exemplary embodiment of the disclosure will be described with reference to the appended drawings. In addition, shapes or relative positions of constituent elements described in the below-described exemplary embodiment should be changed as appropriate according to a configuration or various conditions of an apparatus to which the disclosure is applied, and a scope of the disclosure should not be limited to the below-described exemplary embodiment.

### <Image Forming Processing>

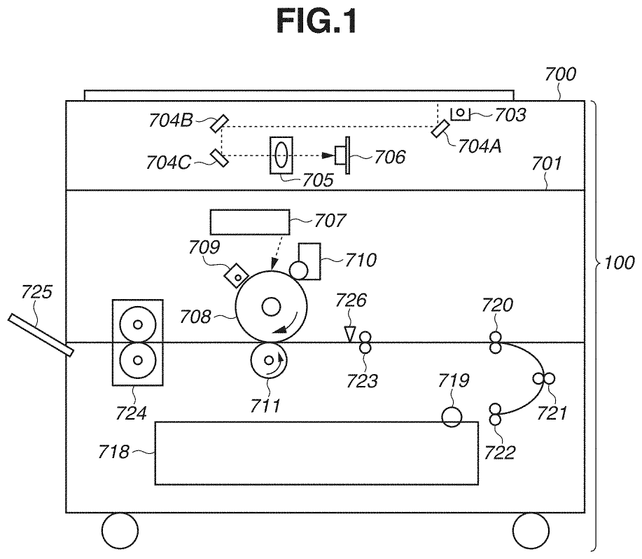

Hereinafter a first exemplary embodiment will be described. FIG. 1 is a cross-sectional diagram illustrating a configuration of an electrophotographic monochrome copying machine (hereinafter, referred to as “image forming apparatus”) 100. In addition, the image forming apparatus 100 is not limited to a copying machine, and may be a facsimile apparatus, a printing apparatus, or a printer. Further, a type of the image forming apparatus may be any one of a monochrome type or a color type.

A configuration and a function of the image forming apparatus 100 will be described below with reference to FIG. 1. As illustrated in FIG. 1, the image forming apparatus 100 includes an image reading apparatus (hereinafter, referred to as “reader”) 700 and an image printing apparatus 701.

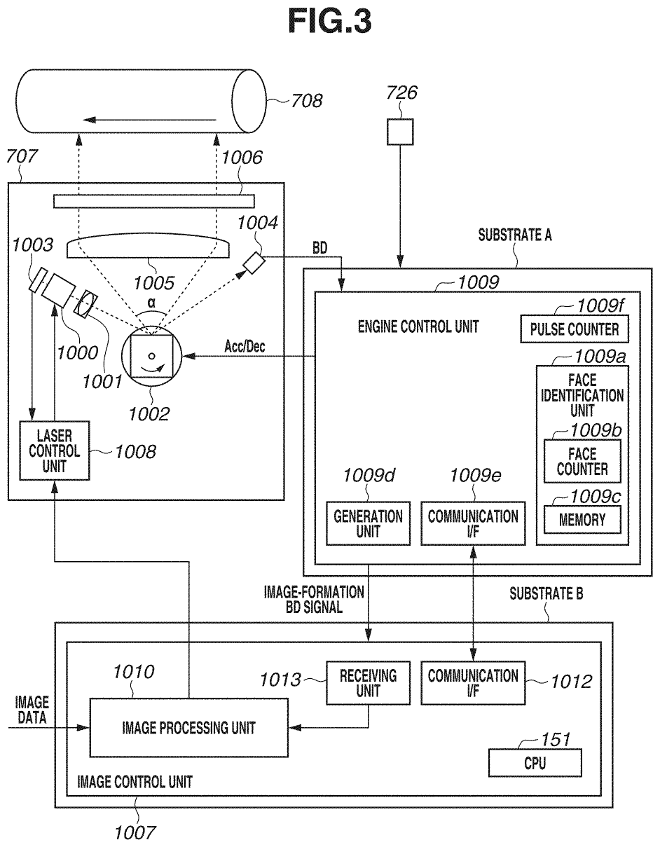

Light emitted from an illumination lamp 703 at a reading position of the reader 700 is reflected on a document and guided to a color sensor 706 through an optical system configured of reflection mirrors 704A, 704B, 704C and a lens 705. The reader 700 reads light incident on the color sensor 706 for each of colors of blue (hereinafter, referred to as “B”), green (hereinafter, referred to as “G”), and red (hereinafter, referred to as “R”) and converts the light into electric image signals. Further, the reader 700 executes color conversion processing based on intensity of image signals B, G, and R to acquire image data, and outputs the image data to an image control unit 1007 described below (see FIG. 3).

A sheet storing tray 718 is arranged inside the image printing apparatus 701. A recording medium stored in the sheet storing tray 718 is fed by a sheet feeding roller 719 and conveyed to a registration roller 723 being in a stopped state through conveyance rollers 722, 721, and 720. A leading edge of the recording medium conveyed in a conveyance direction by the conveyance roller 720 abuts on a nip portion of the stopped registration roller 723. Then, the recording medium is warped by the conveyance roller 720 which further conveys the medium in a state where the leading edge thereof abuts on the nip portion of the stopped registration roller 723. As a result, because of elastic force acting on the recording medium, the leading edge of the recording medium abuts on the nip portion of the registration roller 723, and is placed along the nip portion. Through the above-described operation, skew correction of the recording medium is executed. After skew correction of the recording medium is executed, the registration roller 723 starts conveying the recording medium at a timing described below. In addition, “recording medium” refers to a material such as a sheet of paper, a resin sheet, a fabric, an overhead projector (OHP) sheet, or a label, on which an image is formed by the image forming apparatus.

The image data acquired by the reader 700 is corrected by the image control unit 1007 and input to a laser scanner unit 707 including a laser device and a polygon mirror. An outer circumferential surface of a photosensitive drum 708 is charged by a charging unit 709. After the outer circumferential surface of the photosensitive drum 708 is charged, laser light according to the image data input to the laser scanner unit 707 is emitted from the laser scanner unit 707 to the outer circumferential surface of the photosensitive drum 708. As a result, an electrostatic latent image is formed on a photosensitive layer (photosensitive body) that covers the outer circumferential surface of the photosensitive drum 708. The processing for forming an electrostatic latent image on the photosensitive layer with laser light will be described below.

Subsequently, the electrostatic latent image is developed with toner within a development unit 710, and a toner image is formed on the outer circumferential surface of the photosensitive drum 708. The toner image formed on the photosensitive drum 708 is transferred to the recording medium by a transfer charging unit 711 arranged at a position (transfer position) facing the photosensitive drum 708. The registration roller 723 conveys the recording medium to the transfer position at a timing that the toner image is transferred onto a predetermined position of the recording medium.

As described above, the recording medium on which the toner image is transferred is conveyed to a fixing unit 724 and heated and pressed by the fixing unit 724, so that the toner image is fixed onto the recording medium. The recording medium on which the toner image is fixed is discharged to a discharge tray 725 arranged externally.

As described above, an image is formed on the recording medium by the image forming apparatus 100. A configuration and a function of the image forming apparatus 100 have been described as the above.

### <Configuration for Forming Electrostatic Latent Image>

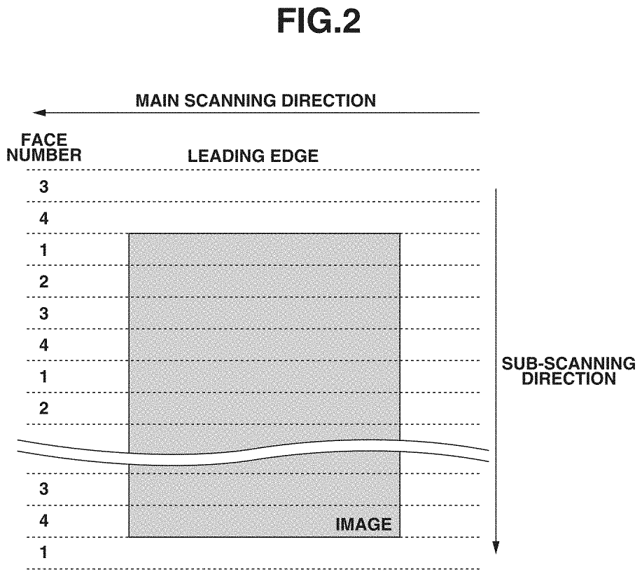

FIG. 2 is a diagram illustrating an image corresponding to one face of the recording medium. A face number in FIG. 2 represents each of the reflection faces included in a polygon mirror 1002. In the present exemplary embodiment, the polygon mirror 1002 has four reflection faces.

As illustrated in FIG. 2, a photosensitive layer is scanned in an axis direction (main scanning direction) of the photosensitive drum 708 with laser light deflected by one reflection face from among the plurality of reflection faces included in the polygon mirror 1002, so that an image (electrostatic latent image) corresponding to one scanning (one line) is formed on the photosensitive layer. Scanning is repeatedly executed with laser light deflected by each of the faces in a rotation direction (sub-scanning direction) of the photosensitive drum 708, so that an electrostatic latent image corresponding to one face of the recording medium is formed on the photosensitive layer.

In the below-described exemplary embodiment, data of an image corresponding to one line of an electrostatic latent image is referred to as image data.

### <Laser Scanner Unit>

FIG. 3 is a block diagram illustrating a configuration of the laser scanner unit 707 in the present exemplary embodiment. A configuration of the laser scanner unit 707 will be described below. In the present exemplary embodiment, as illustrated in FIG. 3, a circuit substrate A on which an engine control unit 1009 is arranged is different from a circuit substrate B on which an image control unit 1007 is arranged. The circuit substrate A on which the engine control unit 1009 is arranged is joined with (connected to) the circuit substrate B on which the image control unit 1007 is arranged via a cable.

As illustrated in FIG. 3, laser light is output from both end portions of a laser light source 1000. The laser light output from one end portion of the laser light source 1000 is incident on the photodiode (PD) 1003. The photodiode 1003 converts the incident laser light into an electric signal and outputs to the laser control unit 1008 as a PD signal. Based on the input PD signal, the laser control unit 1008 executes control (hereinafter, referred to as “auto power control (APC)”) of an output light amount of the laser light source 1000.

On the other hand, laser light output from another end portion of the laser light source 1000 is emitted through a collimator lens 1001 to the polygon mirror 1002 serving as a rotating polygon mirror.

The polygon mirror 1002 is rotationally driven by a polygon motor (not illustrated). The polygon motor is controlled by a driving signal (acceleration/deceleration (Acc/Dec) signal) output from the engine control unit 1009.

The laser light emitted to the rotating polygon mirror 1002 is deflected by the polygon mirror 1002. The outer circumferential surface of the photosensitive drum 708 is scanned with the laser light deflected by the polygon mirror 1002 in a direction from the right to the left illustrated in FIG. 3.

The laser light for scanning the outer circumferential surface of the photosensitive drum 708 is corrected by an F-θ lens 1005 to scan the outer circumferential surface of the photosensitive drum 708 at a constant scanning speed, and is emitted to the outer circumferential surface of the photosensitive drum 708 via a reflecting mirror 1006.

Further, the laser light deflected by the polygon mirror 1002 is incident on a beam detect (BD) sensor 1004 serving as a light receiving unit having an element for receiving the laser light. In the present exemplary embodiment, the BD sensor 1004 is arranged at a position where laser light is emitted to the outer circumferential surface of the photosensitive drum 708 after being detected by the BD sensor 1004 in a period until the BD sensor 1004 detects laser light again after detecting the laser light. Specifically, for example, as illustrated in FIG. 3, the BD sensor 1004 is arranged in an area on the outer side of an area expressed by an angle α from among the area where laser light reflected on the polygon mirror 1002 passes through, which is an area on the upstream side in a scanning direction of laser light.

The BD sensor 1004 generates the BD signal based on the detected laser light and outputs the BD signal to the engine control unit 1009. The engine control unit 1009 controls the polygon motor based on the input BD signal so that the polygon mirror 1002 is rotated in a predetermined rotation period. When a period of the BD signal has become a period corresponding to a predetermined period, the engine control unit 1009 determines that the rotation period of the polygon mirror 1002 has become a predetermined period.

The engine control unit 1009 outputs an image-formation BD signal according to the BD signal input thereto. The image-formation BD signal is synchronized with the BD signal, and generated by a generation unit 1009d through a method described below. The image-formation BD signal corresponds to a signal indicating one scanning period for scanning the photosensitive drum 708 with laser light.

The image control unit 1007 outputs the corrected image data to the laser control unit 1008 according to the image-formation BD signal input to the receiving unit 1013. Specific control structures of the engine control unit 1009 and the image control unit 1007 will be described below.

Based on the input image data, the laser control unit 1008 lights up the laser light source 1000 to generate laser light in order to form an image on the outer circumferential surface of the photosensitive drum 708. As described above, the laser control unit 1008 is controlled by the image control unit 1007 serving as an information processing apparatus. The generated laser light is emitted to the outer circumferential surface of the photosensitive drum 708 through the above-described method.

In addition, a distance L from a position where the sheet sensor 726 detects the recording medium to the transfer position is longer than a distance x from a position on the outer circumferential surface of the photosensitive drum 708, where laser light is emitted, to the transfer position in the rotation direction of the photosensitive drum 708. Specifically, the distance L is equal to a distance acquired by adding the distance x and a distance which the recording medium is conveyed in a period until the laser light is emitted from the laser light source 1000 after the sheet sensor 726 has detected the leading edge of the recording medium. In addition, the image control unit 1007 corrects the image data, and the image control unit 1007 controls the laser control unit 1008 in a period until the laser light is emitted from the laser light source 1000 after the sheet sensor 726 has detected the leading edge of the recording medium.

A configuration of the laser scanner unit 707 has been described as the above.

### <Method of Identifying Face of Polygon Mirror>

The image control unit 1007 sequentially outputs the corrected image data to the laser control unit 1008 from the most upstream image data in the sub-scanning direction corresponding to a period of the image-formation BD signal input thereto. The laser control unit 1008 controls the laser light source 1000 according to the input image data to form an image on the outer circumferential surface of the photosensitive drum 708. In the present exemplary embodiment, the polygon mirror 1002 has four faces. However, the number of faces of the polygon mirror 1002 is not limited to four.

An image is formed on the recording medium by laser light deflected by the plurality of reflection faces included in the polygon mirror 1002. Specifically, for example, as illustrated in FIG. 2, an image corresponding to the most upstream image data in the sub-scanning direction is formed by the laser light deflected by the first face of the polygon mirror 1002. Further, an image corresponding to the second most upstream image data in the sub-scanning direction is formed by the laser light deflected by the second face different from the first face of the polygon mirror 1002. Thus, an image formed on the recording medium consists of images, each of which is formed by laser light reflected on a different reflection face from among the plurality of reflection faces included in the polygon mirror 1002.

In a case where a polygon mirror having four reflection faces is used as the polygon mirror 1002 for deflecting laser light, an angle between two adjacent reflection faces of the polygon mirror 1002 may not be precisely 90 degrees. Specifically, when the polygon mirror 1002 having the four reflection faces is viewed in the rotation axis direction, an angle between two adjacent sides may not be precisely 90 degrees, and, that is, a shape of the polygon mirror 1002 may not be a square shape when viewed in the rotation axis direction. In addition, in a case where a polygon mirror having n-pieces of reflection faces is used (“n” is a positive integer), a shape of the polygon mirror may not be an equilateral shape having n-pieces of angles when viewed in the rotation axis direction.

In a case where the polygon mirror having four reflection faces is used, a position or a size of an image formed by laser light will be different for each of the reflection faces if an angle between two adjacent reflection faces of the polygon mirror is not precisely 90 degrees. As a result, distortion arises in the image formed on the outer circumferential surface of the photosensitive drum 708, and thus distortion also arises in the image formed on the recording medium.

Therefore, in the present exemplary embodiment, correction such as correction of a writing-start position is executed on the image data based on a correction amount (correction data) corresponding to each of the reflection faces included in the polygon mirror 1002. In this case, a structure for identifying the face on which laser light is deflected is provided. Hereinafter, an example of the method for identifying a face on which laser light is deflected will be described. In the present exemplary embodiment, a face identification unit 1009a arranged on the engine control unit 1009 identifies a face on which laser light is deflected (reflected) from among the plurality of reflection faces included in the polygon mirror 1002.

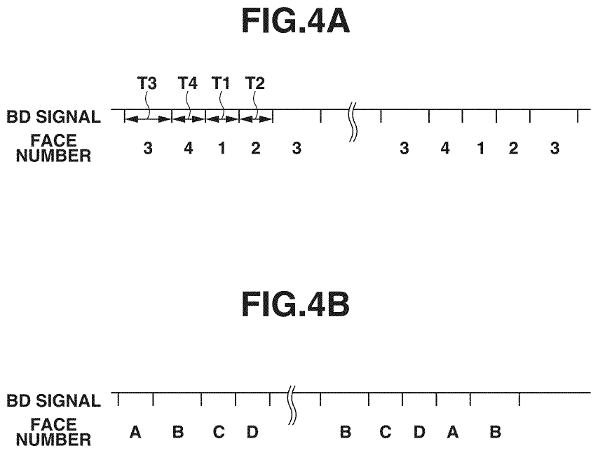

FIG. 4A is a diagram illustrating an example of a relationship between a BD signal generated by scanning a light receiving face of the BD sensor 1004 with laser light and a face number of the face on which the laser light is deflected. As illustrated in FIG. 4A, a time (i.e., scanning period) taken for the BD signal to fall for the first time after a pulse of the BD signal has fallen is different for each of the faces of the polygon mirror 1002. The scanning period corresponds to a time taken for laser light to scan the light receiving face of the BD sensor 1004 again for the first time after scanning the light receiving face thereof.

In FIG. 4A, a period T1 corresponds to a face number 1, a period T2 corresponds to a face number 2, a period T3 corresponds to a face number 3, and a period T4 corresponds to a face number 4. Each of the periods T1 to T4 is stored in a memory 1009c arranged in the face identification unit 1009a.

The face identification unit 1009a identifies the face number of the face on which the laser light is deflected through the following method. Specifically, as illustrated in FIG. 4B, the face identification unit 1009a sets face numbers A to D with respect to four consecutive scanning periods of the BD signal. Then, with respect to each of the face numbers A to D, the face identification unit 1009a measures the scanning period for a plurality of times (e.g., 32 times) and calculates an average value of the measured period of each of the face numbers A to D.

Based on the calculated periods and the periods T1 to T4 stored in the memory 1009c, the engine control unit 1009 identifies a face number, which corresponds to each of the face numbers 1 to 4, from among the face numbers A to D.

As described above, based on the input BD signal, the face identification unit 1009a identifies a face number of a face on which laser light is deflected (i.e., a reflection face used for scanning the photosensitive drum 708 from among the plurality of reflection faces included in the polygon mirror 1002).

### <Engine Control Unit>

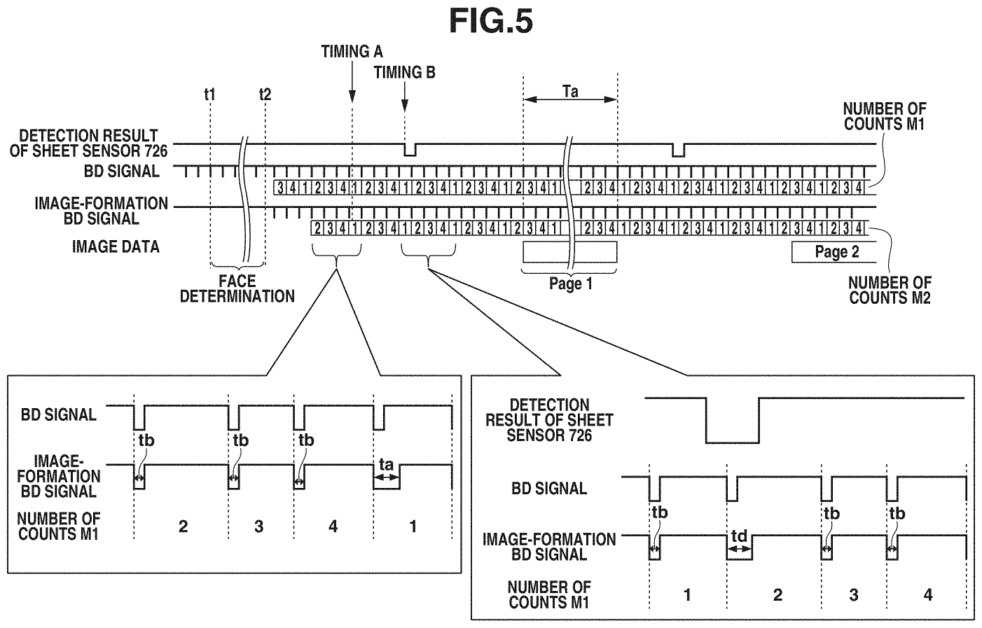

Next, control processing executed by the control unit 1009 according to the present exemplary embodiment will be described with reference to FIGS. 3 and 5.

As illustrated in FIG. 3, the face identification unit 1009a includes a face counter 1009b. The face counter 1009b stores face information indicating a reflection face, which deflects laser light for scanning the light receiving face of the BD sensor 1004 from among the plurality of reflection faces.

FIG. 5 is a time chart illustrating a relationship between various signals and the number of counts M1 of the face counter 1009b. The number of counts M1 of the face counter 1009b corresponds to the face information.

When a rotation period of the polygon mirror 1002 has reached a predetermined period (time t1), the engine control unit 1009 (face identification unit 1009a) executes identification of the face number (i.e., face determination) through the above-described method based on the input BD signal.

The engine control unit 1009 starts counting through the face counter 1009b from a time t2 when identification (estimation) of the face number executed by the face identification unit 1009a is ended. Specifically, when identification of the face number is ended, the engine control unit 1009 sets a face number corresponding to the BD signal input for the first time after ending the identification of the face number, as an initial value of the number of counts M1 of the face counter 1009b. After setting the initial value of the number of counts M1, for example, the engine control unit 1009 updates the number of counts M1 every time the falling edge of the input BD signal is detected. In a case where the polygon mirror 1002 has n-pieces of reflection faces (“n” is a positive integer), “M1” is a positive integer that satisfies a condition “1≤M1≤n”.

After face determination is completed, the generation unit 1009d generates an image-formation BD signal based on the information about the face identified by the face identification unit 1009a and the BD signal output from the BD sensor 1004. Specifically, as illustrated in FIG. 5, the generation unit 1009d sets a time when the image-formation BD signal indicating the identified reflection face (in the present exemplary embodiment, a face 1) is in a low level (L), to a time different from a time when the image-formation BD signal indicating a reflection face different from the identified reflection face is “L”. More specifically, as illustrated in FIG. 5, the time when the image-formation BD signal corresponding to the face number 1 is “L” is set to a time different from the time to be set with respect to the face number 2, 3, or 4. In the present exemplary embodiment, a time to when the image-formation BD signal corresponding to the face number 1 is L is set longer than a time tb when the image-formation BD signal corresponding to the face number 2, 3, or 4 is L. Hereinafter, the processing for setting a time when the image-formation BD signal indicating the identified reflection face is L, to a time different from a time when the image-formation BD signal indicating another reflection face is L, referred to as a first mode.

The engine control unit 1009 outputs a signal generated by the generation unit 1009d as the image-formation BD signal in accordance with (in synchronization with) the BD signal output from the BD sensor 1004.

The image control unit 1007 measures a time when the image-formation BD signal is L through a method described below, and identifies a reflection face corresponding to the input image-formation BD signal based on the measurement result. After identification of the reflection face corresponding to the input image-formation BD signal is completed, the CPU 151 transmits an instruction for executing printing (image formation) to the engine control unit 1009 via the communication I/F 1012.

When the instruction for executing printing is transmitted from the image control unit 1007 via the communication I/F 1090e, the engine control unit 1009 ends the first mode. In other words, the engine control unit 1009 ends the processing for setting the time when the image-formation BD signal indicating the identified reflection face is L, to a time different from the time when the image-formation BD signal indicating another reflection face is L.

Further, when the instruction for executing printing is transmitted from the image control unit 1007 via the communication I/F 1009e at a timing A, the engine control unit 1009 starts driving the registration roller 723. As a result, a leading edge of the recording medium is detected by the sheet sensor 726 at a timing B. In the present exemplary embodiment, a timing when a low level is detected as the detection result in FIG. 5 corresponds to a timing when the sheet sensor 726 has detected a leading edge of the recording medium.

As illustrated in FIG. 3, the sheet sensor 726 that detects arrival of the leading edge of the recording medium is arranged on the downstream side of the registration roller 723 in the conveyance direction of the recording medium, and a detection result thereof is input to the engine control unit 1009.

When a signal indicating that the sheet sensor 726 has detected the leading edge of the recording medium is input to the engine control unit 1009 from the sheet sensor 726, the engine control unit 1009 applies the following processing to the image-formation BD signal that is output for the first time after input of the signal. Specifically, as illustrated in FIG. 5, the engine control unit 1009 (generation unit 1009d) sets a time when the image-formation BD signal output for the first time after input of the signal is “L”, to a time td. In the present exemplary embodiment, the time td is set longer than a time tb when another image-formation BD signal is “L”. Hereinafter, the processing is referred to as “second mode” which sets a time when the image-formation BD signal output for the first time is “L” after the signal indicating that the sheet sensor 726 has detected the leading edge of the recording medium is input, to the time td.

The image control unit 1007 measures a time when the image-formation BD signal is “L” through a method described below, and determines an output timing of image data based on the measurement result. In other words, the signal indicating that the sheet sensor 726 has detected the leading edge of the recording medium functions as a first signal for determining a timing for starting scanning of the photosensitive body. Details thereof will be described below.

As illustrated in FIG. 3, the engine control unit 1009 includes a counter 1009f for counting the number of output pulses of the image-formation BD signal. The engine control unit 1009 stops driving the registration roller 723 when the number of pulses counted by the counter 1009f has reached the number of pulses corresponding to one page of the recording medium (i.e., period Ta).

Thereafter, the engine control unit 1009 restarts driving of the registration roller 723 when the instruction for executing printing is received again.

As described above, the engine control unit 1009 executes the first mode in a period from a time t2 to the timing A, and executes the second mode in a period after the timing A.

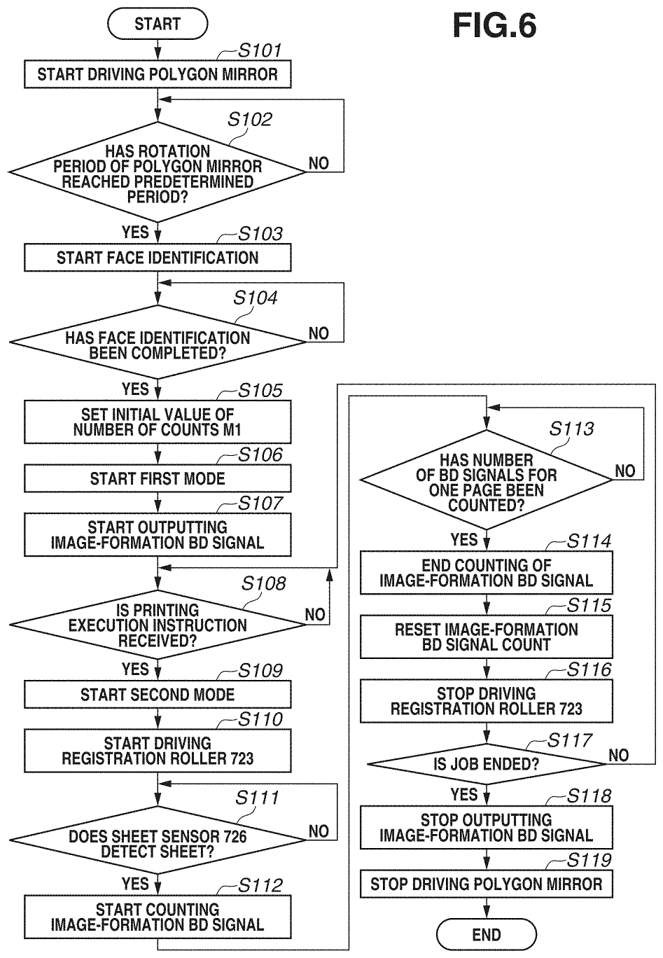

FIG. 6 is a flowchart illustrating control processing executed by the engine control unit 1009 in the present exemplary embodiment. The processing illustrated in the flowchart in FIG. 6 is executed by the engine control unit 1009. Further, in the below-described processing, after face identification is completed, the engine control unit 1009 updates the number of counts M1 every time a falling edge of the input BD signal is detected.

When a print job is started, in step S101, the engine control unit 1009 starts driving a motor (polygon motor) to drive and rotate the polygon mirror 1002.

In step S102, when a rotation period of the polygon mirror 1002 has reached a predetermined period (YES in step S102), the processing proceeds to step S103. In step S103, the engine control unit 1009 starts the face identification at a time t1.

In step S104, when the engine control unit 1009 completes the face identification at a time t2 (YES in step S104), the processing proceeds to step S105.

Thereafter, in step S105, the engine control unit 1009 sets a face number which corresponds to the BD signal input for the first time after identification of the face number is ended, as an initial value of the number of counts M1 of the face counter 1009b. When the initial value is set, the engine control unit 1009 updates the number of counts M1 every time the falling edge of the input BD signal is detected.

In step S106, the engine control unit 1009 executes the first mode. In other words, the engine control unit 1009 sets a time when the image-formation BD signal indicating the identified reflection face is to the time to that is different from the time tb when the image-formation BD signal indicating another reflection face is ‘L’.

Then, in step S107, the engine control unit 1009 starts outputting the image-formation BD signal.

In step S108, when the engine control unit 1009 receives an instruction for forming an image on a recording medium from the CPU 151 (YES in step S108), the processing proceeds to step S109. In step S109, the engine control unit 1009 executes the second mode. In other words, with respect to the image-formation BD signal that is to be output for the first time after input of the signal indicating that the sheet sensor 726 has detected the leading edge of the recording medium, the engine control unit 1009 sets a time when the image-formation BD signal is at “L”, to the time td.

Then, in step S110, the engine control unit 1009 starts driving the registration roller 723. As a result, conveyance of the recording medium is started.

Thereafter, in step S111, when the engine control unit 1009 receives the signal indicating that the sheet sensor 726 has detected the leading edge of the recording medium (YES in step S111), the processing proceeds to step S112. In step S112, the engine control unit 1009 starts counting the pulses of the image-formation BD signal that has been output. For example, the engine control unit 1009 counts the falling edges of the pulses of the output image-formation BD signal.

In step S113, when the number of counted pulses has reached the number of pulses corresponding to one page of the recording medium (period Ta) (YES in step S113), the processing proceeds to step S114. In step S114, the engine control unit 1009 ends counting of the pulses of the output image-formation BD signal. In step S115, the engine control unit 1009 resets the number of counts.

Further, in step S116, the engine control unit 1009 stops driving the registration roller 723.

Next, in step S117, if the print job is not ended (NO in step S117), the processing returns to step S108 again.

In step S117, if the print job is ended (YES in step S117), the processing proceeds to step S118. In step S118, the engine control unit 1009 stops outputting the image-formation BD signal. In step S119, the engine control unit 1009 stops driving the polygon mirror 1002 and ends the processing of this flowchart.

The control processing executed by the engine control unit 1009 has been described as the above.

### <Image Control Unit>

### <Face Identification Method Executed by Image Processing Unit>

Next, control processing executed by the image control unit 1007 will be described. As illustrated in FIG. 3, the image control unit 1007 includes an image processing unit 1010. The image processing unit 1010 identifies face information indicating a reflection face that deflects laser light for scanning a light receiving face of the BD sensor 1004 from among a plurality of reflection faces, and corrects the image data based on the face information. Hereinafter, a function of the image processing unit 1010 will be described.

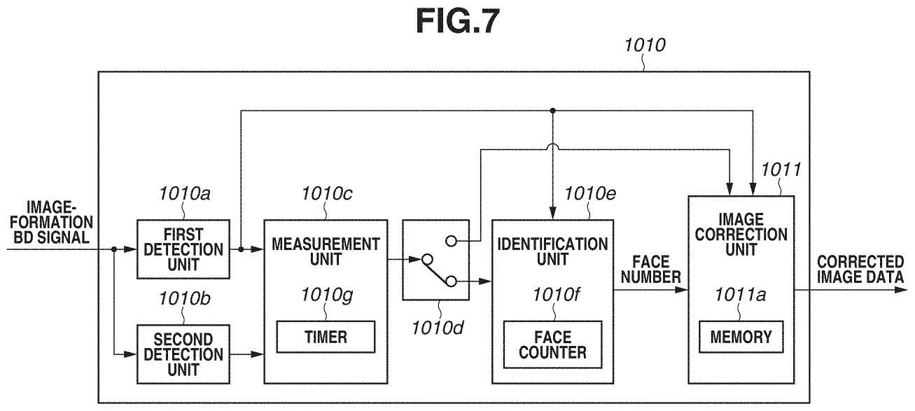

FIG. 7 is a block diagram illustrating an example of a configuration of the image processing unit 1010. As illustrated in FIG. 7, the image processing unit 1010 includes a first detection unit 1010a for detecting a falling edge (i.e., a change of a level from “H” to “L”) of the image-formation BD signal input thereto, and a second detection unit 1010b for detecting a rising edge (i.e., a change of a level from “L” to “H”) of the image-formation BD signal input thereto. Further, the image processing unit 1010 includes a measurement unit 1010c for measuring a time when the image-formation BD signal is “L” based on the detection results of the first detection unit 1010a and the second detection unit 1010b. The image processing unit 1010 further includes an identification unit 1010e for identifying a reflection face on which laser light for scanning the light receiving face of the BD sensor 1004 is deflected, from among the plurality of reflection faces. Furthermore, the image processing unit 1010 includes an image correction unit 1011 for correcting image data based on the information about the reflection face identified by the identification unit 1010e.

The first detection unit 1010a detects a falling edge of the input image-formation BD signal and outputs a signal indicating detection of the falling edge to the measurement unit 1010c, the identification unit 1010e, and the image correction unit 1011.

Further, the second detection unit 1010b detects a rising edge of the input image-formation BD signal and outputs a signal indicating detection of the rising edge to the measurement unit 1010c.

The measurement unit 1010c includes a timer 1010g for measuring a time. The measurement unit 1010c uses the timer 1010g to measure a time t taken for the second detection unit 1010b to output the signal indicating detection of a rising edge after the first detection unit 1010a outputs the signal indicating detection of a falling edge.

The measurement unit 1010c outputs “1” as a signal indicating the measurement result if the measured time t is a predetermined period tc or longer. Further, the measurement unit 1010c outputs “0” as a signal indicating the measurement result if the measured time t is shorter than the predetermined period tc. The predetermined period tc is set to a period shorter than the time to and td and longer than the time tb.

In a period until the identification unit 1010e completes identification of the reflection face after the print job is started, the image processing unit 1010 controls a state of the switch 1010d to input a measurement result acquired by the measurement unit 1010c to the identification unit 1010e.

The identification unit 1010e identifies a reflection face based on the measurement result of the timer 1010g. Specifically, if “1” is input as a signal indicating the measurement result, the identification unit 1010e determines that the image-formation BD signal (i.e., a signal as a measurement target of the timer 1010g) input to the image control unit 1007 is a signal indicating the face 1.

The identification unit 1010e includes a face counter 1010f for storing face information indicating the identified reflection face. The number of counts M2 of the face counter 1010f corresponds to the face information. When the identification unit 1010e determines that the image-formation BD signal input to the image control unit 1007 is a signal indicating the face 1, the identification unit 1010e sets the number of counts M2 of the face counter 1010f to “1”.

The identification unit 1010e updates the number of counts M2 of the face counter 1010f every time the signal indicating detection of the falling edge is output from the first detection unit 1010a. The number of counts M2 of the face counter 1010f is output to the image correction unit 1011 as a face number. In a case where the polygon mirror 1002 has n-pieces of reflection faces (“n” is a positive integer), “M2” is a positive integer that satisfies a condition “1≤M2≤n”.

### <Output Timing of Image Data>

In a period after the identification unit 1010e has completed identification of the reflection face, the image processing unit 1010 controls a state of the switch 1010d to input a measurement result of the measurement unit 1010c to the image correction unit 1011.

Based on the measurement result of the measurement unit 1010c, the image correction unit 1011 determines a timing for starting output of the corrected image data. Specifically, the image correction unit 1011 starts outputting the corrected image data when y-pieces (in the present exemplary embodiment, 8 pieces) of image-formation BD signals have been input after “1” is output as the signal indicating a measurement result (i.e., output of the corrected image data is started from the ninth pulse). The image correction unit 1011 outputs the corrected image data when the signal indicating detection of the falling edge is output from the first detection unit 1010a. A correction method of image data executed by the image correction unit 1011 will be described below.

As described above, in the present exemplary embodiment, when 8 pulses of the image-formation BD signal are output after “1” is output from the measurement unit 1010c as a signal indicating the measurement result, output of the corrected image data is started. As a result, an image is formed on a predetermined position of a recording medium.

### <Correction of Image Data>

The image correction unit 1011 sequentially corrects the image data from image data A which is the most upstream image data in the sub-scanning direction from among the plurality of pieces of data constituting an image for one page illustrated in FIG. 2. Specifically, for example, in a case where an image corresponding to the image data A is an image formed by the laser light deflected on the reflection face corresponding to the face number 1, the image correction unit 1011 executes correction corresponding to the face number 1 on the image data A. More specifically, the image correction unit 1011 reads out correction data corresponding to the face number “1” from the memory 1011a. Then, the image correction unit 1011 corrects the image data A based on the read correction data. Then, from among the plurality of pieces of image data further on the downstream side than the image data A in the sub-scanning direction, the image correction unit 1011 corrects the most upstream image data B based on the correction data corresponding to the face number “2” stored in the memory 1011a. As described above, the correction data corresponding to the respective face numbers is stored in the memory 1011a in association with the face number.

Through the above-described configuration, laser light corresponding to the image data corrected based on the correction data corresponding to the face number “m” (“m” is an integer from 1 to 4) is deflected by the reflection face corresponding to the face number “m”.

The image correction unit 1011 executes the above-described processing until correction of image data for one face of the recording medium is completed.

The image correction unit 1011 sequentially outputs the image data corrected for each of the areas as described above to the laser control unit 1008 from the image data on the downstream side (i.e., from the image data A) for each of the areas. The image correction unit 1011 outputs a piece of image data to the laser control unit 1008 every time a falling edge of the image-formation BD signal is detected (i.e., in a cycle of the image-formation BD signal). In the present exemplary embodiment, the image correction unit 1011 corrects image data and outputs the corrected image data in synchronization with the image-formation BD signal. However, the configuration is not limited thereto. For example, the image correction unit 1011 may be configured to previously correct the image data based on the number of counts M2, and output the previously corrected image data to the laser control unit 1008 in synchronization with the image-formation BD signal.

A counter (not illustrated) for counting the number of pieces of output image data is built into the image correction unit 1011, such that output of image data is stopped when a counted value of the counter has reached a value corresponding to one sheet (one page) of the recording medium.

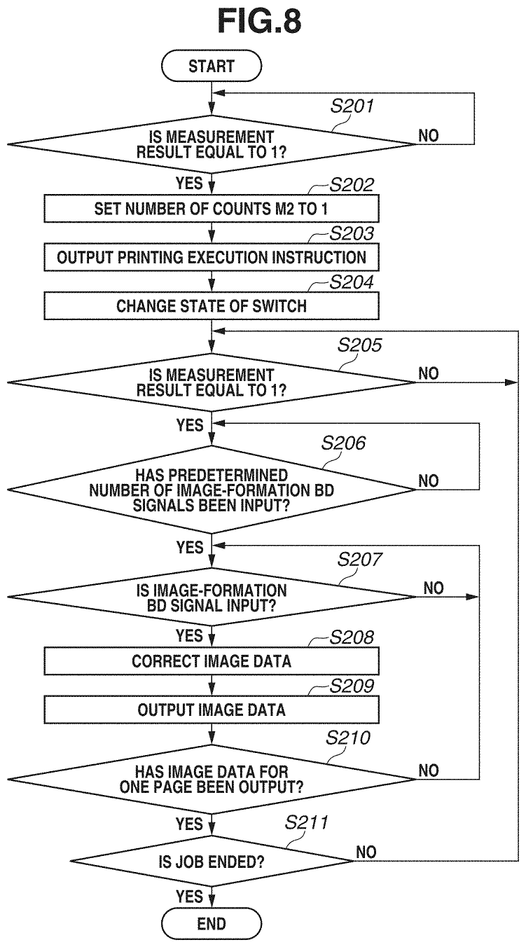

FIG. 8 is a flowchart illustrating control processing executed by the image control unit 1007. The processing illustrated in the flowchart in FIG. 8 is executed by the CPU 151. In the processing described below, the face number output from the identification unit 1010e to the image correction unit 1011 is updated every time the number of counts M2 is updated. Further, during a period in which the flowchart in FIG. 8 is being executed, the image control unit 1007 (image correction unit 1011) counts the number of areas of the output image data. Further, when the flowchart in FIG. 8 is started, the switch 1010d is brought into a state where a measurement result of the measurement unit 1010c is input to the identification unit 1010e.

After a print job is started, in step S201, when “1” is output from the measurement unit 1010c as a signal indicating the measurement result (YES in step S201), the processing proceeds to step S202. In step S202, the CPU 151 controls the identification unit 1010e to set the value of the face counter 1010f to “1”. As a result, the identification unit 1010e sets the value of the face counter 1010f to “1”.

Thereafter, in step S203, the CPU 151 outputs an instruction for executing printing to the engine control unit 1009 via the communication I/F 1012.

Further, in step S204, the CPU 151 controls a state of the switch 1010d to input a measurement result of the measurement unit 1010c to the image correction unit 1011. As a result, the measurement result of the measurement unit 1010c is input to the image correction unit 1011.

In step S205, when “1” is output from the measurement unit 1010c as a signal indicating the measurement result (YES in step S205), the processing proceeds to step S206.

In step S206, when a predetermined number of image-formation BD signals (in the present exemplary embodiment, 8 pieces) are input, i.e., when a falling edge of the image-formation BD signal is detected a predetermined number of times, (YES in step S206), the processing proceeds to step S207.

In step S207, if a next image-formation BD signal is input (in the present exemplary embodiment, a ninth image-formation BD signal) (YES in step S207), the processing proceeds to step S208. In step S208, the CPU 151 controls the image correction unit 1011 to correct the image data based on the face number indicated by the number of counts M2. As a result, the image correction unit 1011 corrects the image data based on the face number indicated by the number of counts M2.

Then, in step S209, the CPU 151 controls the image correction unit 1011 to output the image data corrected in step S208 to the laser control unit 1008 in synchronization with the image-formation BD signal. As a result, the corrected image data is output to the laser control unit 1008 in synchronization with the image-formation BD signal.

The image control unit 1007 repeatedly executes the processing in steps S207 to S210 until the image data corresponding to one face (one page) of the recording medium is output.

Thereafter, the CPU 151 repeatedly executes the above-described processing until the print job is ended.

As described above, in the present exemplary embodiment, in a period from the time t2 to the timing A, the engine control unit 1009 sets a time when the image-formation BD signal indicating the identified reflection face (in the present exemplary embodiment, the face “1”) is “L”, to the time to which is different from a time when the image-formation BD signal indicating another reflection face is “L”. If “1” is output from the measurement unit 1010c as a signal indicating the measurement result, the identification unit 1010e determines that the reflection face indicated by the image-formation BD signal input to the image control unit 1007 is the reflection face “1”. As a result, the image control unit 1007 can identify the reflection face which deflects laser light for scanning the photosensitive body.

Further, in a period after the timing A, with respect to the image-formation BD signal that is to be output for the first time after the signal indicating that the sheet sensor 726 has detected the leading edge of the recording medium is input, the engine control unit 1009 sets the time when the image-formation BD signal is L, to the time td, regardless of the reflection face which corresponds to the image-formation BD signal. In other words, with respect to the image-formation BD signal that is to be output for the first time after he signal indicating that the sheet sensor 726 has detected the leading edge of the recording medium is input, the engine control unit 1009 sets a time when the image-formation BD signal is L, to the time td, if the image control unit 1007 has identified the reflection face. The image correction unit 1011 starts outputting the corrected image data when y-pieces (in the present exemplary embodiment, 8 pieces) of image-formation BD signals have been input after “1” is output as a signal indicating the measurement result (i.e., output of the corrected image data is started from the ninth pulse). As a consequence, a signal line for transmitting a signal that determines a timing of starting image formation to the image control unit 1007 from the engine control unit 1009, can be reduced, and thus increase in cost can be suppressed. Further, according to the present exemplary embodiment, since the image-formation BD signal output from the engine control unit 1009 to the image control unit 1007 is not stopped, face identification does not have to be executed every time image formation of one face of the recording medium is executed. Therefore, decrease of productivity in image formation of one face of the recording medium can be suppressed. In other words, through the configuration according to the present exemplary embodiment, the decrease of productivity in image formation of one face of the recording medium can be suppressed while suppressing increase in cost.

In the present exemplary embodiment, the time to when the image-formation BD signal indicating the identified reflection face is “L” in a period from the time t2 to the timing A, is set different from the time td when the image-formation BD signal that is to be output for the first time after the signal indicating that the sheet sensor 726 has detected the leading edge of the recording medium is input, is “L” in a period after the timing A. However, the configuration is not limited thereto. In other words, the time to may be a same time as the time td.

Further, in the present exemplary embodiment, in both of the period when the first mode is executed and the period when the second mode is executed, the measurement unit 1010c outputs “1” as the signal indicating a measurement result if the measurement time t is the predetermined period tc or longer. However, the configuration is not limited thereto. For example, the measurement unit 1010c may output “1” as a signal indicating a measurement result if the measurement time t is the predetermined period tc or longer in a period when the first mode is executed. Then, in a period when the second mode is executed, the measurement unit 1010c may output “1” as a signal indicating a measurement result if the measurement time t is a predetermined period tc′ or longer. In addition, the predetermined period tc′ is set shorter than the time td, and longer than the time tb.

Further, in the present exemplary embodiment, with respect to the image-formation BD signal that is output for the first time after the signal indicating that the sheet sensor 726 has detected the leading edge of the recording medium is input, the time when the image-formation BD signal is L is set to the time td. However, the configuration is not limited thereto. For example, with respect to the image-formation BD signal output for a k-th time (“k” is a positive integer) after the signal indicating that the sheet sensor 726 has detected the leading edge of the recording medium is input, the time when the image-formation BD signal is L may be set to the time td. In other words, a length of the “L” level period corresponding to the reflection face used for executing scanning of the photosensitive body for the k-th time may be set to the time td that is longer than a length of the “L” level period corresponding to the reflection face used for executing scanning of the photosensitive body for a (k−1)-th time.

Further, in the present exemplary embodiment, the engine control unit 1009 starts driving the registration roller 723 when an instruction for starting image formation is output from the image control unit 1007. However, a trigger for starting driving of the registration roller 723 is not limited to the instruction for starting image formation issued from the image control unit 1007. For example, the engine control unit 1009 may start driving the registration roller 723 when a predetermined time has passed after the image-formation BD signal indicating the identified reflection face is “L” is set to the time to (i.e., after the first mode is started).

Further, in the present exemplary embodiment, the face number is determined based on the time when the image-formation BD signal output from the engine control unit 1009 is “L”. However, the configuration is not limited thereto. For example, the identification unit 1010e may determine the face number based on a time when the image-formation BD signal output from the engine control unit 1009 is “H (high-level)”.

While the present exemplary embodiment has been described with respect to an electrophotographic monochrome copying machine, the configuration described in the present exemplary embodiment is also applicable to an electrophotographic color copying machine.

Further, in the present exemplary embodiment, the engine control unit 1009 starts counting the number of pulses of the output image-formation BD signal when the engine control unit 1009 starts outputting the image-formation BD signal. However, the configuration is not limited thereto. For example, the engine control unit 1009 may start counting the number of pulses of the output image-formation BD signal when the image control unit 1007 starts outputting the image data to the laser control unit 1008.

The laser light source 1000, the polygon mirror 1002, the photosensitive drum 708, the BD sensor 1004, and the engine control unit 1009 of the present exemplary embodiment are included in the image forming unit.

Further, in the present exemplary embodiment, the image control unit 1007 outputs the corrected image data to the laser control unit 1008. However, the configuration is not limited thereto. For example, the image control unit 1007 may be configured to output the corrected image data to the engine control unit 1009, and the engine control unit 1009 may output the image data to the laser control unit 1008. In other words, the image control unit 1007 may output the corrected image data to the image forming unit.

Further, in the present exemplary embodiment, the sheet sensor 726 is arranged at a position further on the upstream side than the transfer position and further on the downstream side than the registration roller 723. However, the configuration is not limited thereto. For example, the sheet sensor 726 may be arranged at a position further on the upstream side than the registration roller 723.

Further, in the present exemplary embodiment, scanning of the photosensitive drum with laser light (i.e., formation of an electrostatic latent image) is started after the recording medium stored in the sheet storing tray is fed. However, the configuration is not limited thereto. For example, the recording medium stored in the sheet storing tray may be fed after scanning of the photosensitive drum with laser light is started.

Further, in the present exemplary embodiment, as illustrated in FIGS. 4 and 5, the face number is identified based on the period of the BD signal. However, the method of identifying the face number is not limited thereto. For example, the face number may be identified based on a phase difference between the BD signal and a signal (e.g., a signal of an encoder or a frequency generator (FG) signal) which indicates a rotation period of a motor for rotationally driving the polygon mirror.

According to the aspect of the embodiments, decrease of productivity in image formation of one face of the recording medium can be suppressed while suppressing increase in cost.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-142459, filed Jul. 30, 2018, which is hereby incorporated by reference herein in its entirety.

What is claimed is:

1. An information processing apparatus connected to an image forming apparatus including an image forming unit,
the image forming unit comprising:
a first receiver configured to receive image data;
a light source configured to output light based on the image data received by the first receiver;
a photosensitive member;
a rotational polygon mirror having a plurality of reflection faces, configured to be rotated to scan the photosensitive member by deflecting the light output from the light source using the plurality of reflection faces;
a light receiving unit configured to receive the deflected light;
an identifier configured to identify a reflection face to be used for scanning the photosensitive member from among the plurality of reflection faces based on a light receiving result of the light receiving unit;
a first outputting unit configured to output a first signal for determining a timing of starting the scanning of the photosensitive member with the light; and
a generator configured to generate a second signal having a signal at a first level and a signal at a second level,
wherein, in a period until the first signal is output from the first outputting unit after the identifier has completed identification of the reflection face, the generator generates the second signal based on the information about the identified reflection face such that a first length as a length of a period of the first level corresponding to the identified reflection face from among the plurality of reflection faces is different from a second length as a length of a period of the first level corresponding to reflection faces other than the identified reflection face, and
wherein, when the first signal is output from the first outputting unit, the generator generates the second signal such that a third length as a length of a period of the first level corresponding to a first reflection face from among the plurality of reflection faces is different from a fourth length as a length of a period of the first level corresponding to a second reflection face which is different from the first reflection face from among the plurality of reflection faces, and
the information processing apparatus comprising:
a second receiver configured to receive the second signal;
a measurement unit configured to measure a length of a period when the received second signal is at the first level;
a determiner configured to determine a reflection face to be used for scanning the photosensitive member based on the measured length of the period and on a change of the second signal from the second level to the first level;
a memory configured to store a plurality of pieces of correction data respectively corresponding to the plurality of reflection faces;
a corrector configured to correct the image data corresponding to the reflection face based on the stored correction data and on information indicating the determined reflection face; and
a second outputting unit configured to start outputting the corrected image data to the image forming unit based on the measured length of the period after the determiner determines the reflection face.

2. The information processing apparatus according to claim 1,
wherein the first length is longer than the second length, and
wherein, in a case where the measured length of the period is longer than a predetermined period that is shorter than the first length and longer than the second length, the determiner determines that a reflection face corresponding to the measurement target period of the first level is the identified reflection face.

3. The information processing apparatus according to claim 2, further comprising:
a detector configured to detect a change of the second signal from the second level to the first level,
wherein, after the identified reflection face is determined, the determiner updates face information indicating the reflection face every time the detector detects the change, and
wherein the corrector corrects the image data corresponding to the reflection face based on the face information and the stored correction data.

4. The information processing apparatus according to claim 3, wherein the detector detects a falling edge at which the second signal is changed from a high level as the second level to a low level as the first level.

5. The information processing apparatus according to claim 1,
wherein the third length is longer than the fourth length, and
wherein the second outputting unit starts outputting the corrected image data to the image forming unit, when a length of the period longer than a second predetermined period that is shorter than the third length and longer than the fourth length, is measured after the determiner determines the reflection face.

6. The information processing apparatus according to claim 1,
wherein the first length is longer than the second length,
wherein, in a case where the measured length of the period is longer than a predetermined period, the determiner determines that a reflection face corresponding to the measurement target period of the first level is the identified reflection face,
wherein the third length is longer than the fourth length,
wherein the second outputting unit starts outputting the corrected image data to the image forming unit when a length of the period longer than the second predetermined period is measured after the determiner determines the reflection face, and
wherein a length of the predetermined period is a same length as the length of the second predetermined period.

7. The information processing apparatus according to claim 1, wherein the measured length of time is measured by measuring a time taken for the second signal to change from the first level to the second level after the second signal changes from the second level to the first level.

8. The information processing apparatus according to claim 1,
wherein a circuit substrate on which the second receiver is arranged is different from a circuit substrate on which the generator is arranged, and
wherein the circuit substrate on which the second receiver is arranged is connected through a cable to the circuit substrate on which the generator is arranged.

9. An information processing apparatus connected to an image forming apparatus including an image forming unit,
the image forming unit comprising:
a first receiver configured to receive image data;
a light source configured to output light based on the image data received by the first receiver;
a photosensitive member;
a rotational polygon mirror having a plurality of reflection faces, configured to be rotated to scan the photosensitive member by deflecting the light output from the light source by using the plurality of reflection faces;
a light receiving unit configured to receive the light deflected by the rotational polygon mirror;
an identifier configured to identify a reflection face to be used for scanning the photosensitive member from among the plurality of reflection faces based on a light receiving result of the light receiving unit;
a first outputting unit configured to output a first signal for determining a timing of starting the scanning of the photosensitive member with the light; and
a generator configured to generate a second signal having a signal at a first level and a signal at a second level,
wherein, in a period until the first signal is output from the first outputting unit after the identifier has completed identification of the reflection face, the generator generates the second signal based on information about the identified reflection face such that a first length as a length of a period of the first level corresponding to the identified reflection face from among the plurality of reflection faces is different from a second length as a length of a period of the first level corresponding to reflection faces other than the identified reflection face, and
wherein, when the first signal is output from the first outputting unit, the generator generates the second signal such that a length of a period of the first level corresponding to at least one reflection face from among the plurality of reflection faces is longer than a predetermined length, and
the information processing apparatus comprising:
a second receiver configured to receive the second signal;
a measurement unit configured to measure a length of a period when the received second signal is at the first level;
a determiner configured to determine a reflection face used for scanning the photosensitive member based on the measured length of the period and a change of the second signal from the second level to the first level;
a memory configured to store a plurality of pieces of correction data respectively corresponding to the plurality of reflection faces;
a corrector configured to correct the image data corresponding to the reflection face based on the stored data and information indicating the determined reflection face; and
a second outputting unit configured to start outputting the corrected image data to the image forming unit when the measured length of the period after the determiner determines the reflection face is longer than the predetermined length.

10. An image forming apparatus including a first generator for generating image data and an image forming unit for executing image formation on a recording medium based on the image data output from the first generator,
the image forming unit comprising:
a first receiver configured to receive image data;
a light source configured to output light based on the received image data;
a photosensitive member;
a rotational polygon mirror having a plurality of reflection faces, configured to be rotated to scan the photosensitive member by deflecting the light output from the light source by using the plurality of reflection faces;
a light receiving unit configured to receive the light deflected by the rotational polygon mirror;
an identifier configured to identify a reflection face to be used for scanning the photosensitive member from among the plurality of reflection faces based on the received light;
a first outputting unit configured to output a first signal for determining a timing of starting the scanning of the photosensitive member with the light; and
a second generator configured to generate a second signal having a signal at a first level and a signal at a second level,
wherein, in a period until the first signal is output from the first outputting unit after the identifier has completed identification of the reflection face, the second generator generates the second signal based on information about the identified reflection face such that a first length as a length of a period of the first level corresponding to the identified reflection face from among the plurality of reflection faces is different from a second length as a length of a period of the first level corresponding to reflection faces other than the identified reflection face, and
wherein, when the first signal is output from the first outputting unit, the second generator generates the second signal such that a third length as a length of a period of the first level corresponding to a first reflection face from among the plurality of reflection faces is different from a fourth length as a length of a period of the first level corresponding to a second reflection face from among the plurality of reflection faces, and
the first generator comprising:
a second receiver configured to receive the second signal;
a measurement unit configured to measure a length of a period when the received second signal is at the first level;
a determiner configured to determine a reflection face to be used for scanning the photosensitive member based on the measured length of the period and a change of the second signal from the second level to the first level;
a memory configured to store a plurality of pieces of correction data respectively corresponding to the plurality of reflection faces;
a corrector configured to correct the image data corresponding to the reflection face based on the stored correction data and information indicating the determined reflection face; and
a second outputting unit configured to start outputting the corrected image data to the image forming unit based on the measured length of the period after the determiner determines the reflection face.

11. The image forming apparatus according to claim 10,
wherein the first outputting unit includes a sheet sensor for detecting a leading edge of the conveyed recording medium, and
wherein the first signal is a signal indicating that the sheet sensor has detected the leading edge of the recording medium.

12. The image forming apparatus according to claim 10,
wherein, when determination of a reflection face to be used for scanning the photosensitive body has been completed, the first generator outputs a signal indicating completion of determination of a reflection face to be used for scanning the photosensitive member to the image forming unit, and
wherein the first signal is output from the first outputting unit after the signal indicating completion of determination of a reflection face to be used for scanning the photosensitive member is output from the first generator.

13. The image forming apparatus according to claim 10,
the image forming unit further comprising:
a conveyance unit configured to convey a recording medium;
a development unit configured to develop a latent image formed on the photosensitive member;
a transfer unit configured to transfer a toner image developed by the development unit onto the conveyed recording medium; and a sheet sensor arranged at a position further on an upstream side than a transfer position where the toner image is transferred onto the recording medium, in a conveyance direction that the recording medium is conveyed, and configured to detect a leading edge of the conveyed recording medium,
wherein, when determination of a reflection face to be used for scanning the photosensitive member has been completed, the first generator outputs a signal indicating completion of determination of a reflection face to be used for scanning the photosensitive body to the image forming unit,
wherein, when the signal indicating completion of determination of a reflection face to be used for scanning the photosensitive member is output from the first generator, the image forming unit starts conveying the recording medium, and
wherein the first outputting unit outputs the first signal when the sheet sensor has detected the recording medium that is conveyed in a case where the signal indicating completion of determination of a reflection face to be used for scanning the photosensitive member is output from the first generator.

14. The image forming apparatus according to claim 13, wherein the sheet sensor is arranged at a position between a conveyance roller for correcting skew of the conveyed recording medium and the transfer position, and arranged at a position further on an upstream side than the transfer position in the conveyance direction.

15. The image forming apparatus according to claim 12,
wherein the first length is longer than the second length, and
wherein, in a case where the measured length of the period is longer than a predetermined period that is shorter than the first length and longer than the second length, the determiner determines that a reflection face corresponding to the measurement target period of the first level is the identified reflection face.

16. The image forming apparatus according to claim 15, further comprising:
a detector configured to detect a change of the second signal from the second level to the first level,
wherein, after the identified reflection face is determined, the determiner updates face information indicating the reflection face every time the detector detects the change, and
wherein the corrector corrects the image data corresponding to the reflection face based on the face information and the stored correction data.

17. The image forming apparatus according to claim 16, wherein the detector detects a falling edge at which the second signal is changed from a high level as the second level to a low level as the first level.

18. The image forming apparatus according to claim 10,
wherein the third length is longer than the fourth length, and
wherein the second outputting unit starts outputting the corrected image data to the image forming unit when a length of the period longer than a second predetermined period that is shorter than the third length and longer than the fourth length is measured after the determiner determines the reflection face.

19. The image forming apparatus according to claim 10,
wherein the first length is longer than the second length,
wherein, in a case where the measured length of the period is longer than a predetermined period, the determiner determines that a reflection face corresponding to the measurement target period of the first level is the identified reflection face,
wherein the third length is longer than the fourth length,
wherein the second outputting unit starts outputting the corrected image data to the image forming unit when a length of the period longer than a second predetermined period is measured after the determiner determines the reflection face, and
wherein a length of the predetermined period is a same length as a length of the second predetermined period.

20. The image forming apparatus according to claim 10, wherein the measurement unit measures a length of time when the second signal is at the first level, by measuring a time taken for the second signal to change from the first level to the second level after the second signal changes from the second level to the first level.

21. An image forming apparatus including a first generator for generating image data and an image forming unit for executing image formation on a recording medium based on the image data output from the first generator,
the image forming unit comprising:
a first receiver configured to receive image data;
a light source configured to output light based on the received image data;
a photosensitive member;
a rotational polygon mirror having a plurality of reflection faces, configured to be rotated to scan the photosensitive member by deflecting the light output from the light source by using the plurality of reflection faces;
a light receiving unit configured to receive the light deflected by the rotational polygon mirror;
an identifier configured to identify a reflection face to be used for scanning the photosensitive member from among the plurality of reflection faces based on a light receiving result of the light receiving unit;
a first outputting unit configured to output a first signal for determining a timing of starting the scanning of the photosensitive member with the light; and
a second generator configured to generate a second signal having a signal at a first level and a signal at a second level,
wherein, in a period until the first signal is output from the first outputting unit after the identifier has completed identification of the reflection face, the second generator generates the second signal based on information about the identified reflection face such that a first length as a length of a period of the first level corresponding to the identified reflection face from among the plurality of reflection faces is different from a second length as a length of a period of the first level corresponding to reflection faces other than the identified reflection face, and
wherein, when the first signal is output from the first outputting unit, the second generator generates the second signal such that a length of a period of the first level corresponding to at least one reflection face from among the plurality of reflection faces is longer than a predetermined length, and
the first generator comprising:
a second receiver configured to receive the second signal;
a measurement unit configured to measure a length of a period when the second signal received by the second receiver is at the first level;
a determiner configured to determine a reflection face to be used for scanning the photosensitive member based on the measured length of the period and a change of the second signal from the second level to the first level;
a memory configured to store a plurality of pieces of correction data respectively corresponding to the plurality of reflection faces;
a corrector configured to correct the image data corresponding to the reflection face based on the stored correction data and information indicating the determined reflection face; and
a second outputting unit configured to start outputting the corrected image data to the image forming unit when the measured length of the period after the determiner determines the reflection face is longer than the predetermined length.
